(19) United States
(12) Patent Application Publication
(10) Pub. No.: US 2004/0237901 A1
(43) Pub. Date: Dec. 2, 2004

(54) Pet mat

(76) Inventors: Jonathan Willinger, Tenafly, NJ (US); Klaus Woltmann, Demarest, NJ (US)

Correspondence Address: KATTEN MUCHIN ZAVIS ROSENMAN, 575 MADISON AVENUE, NEW YORK, NY, 10022-2585, US

(21) Appl. No.: 10/824,199

(22) Filed: Apr. 14, 2004

Related U.S. Application Data
(60) Provisional application No. 60/462,757, filed on Apr. 14, 2003.

(51) Int. Cl. A01K 5/01

(52) U.S. Cl. 119/61.54

(57) ABSTRACT

A pet mat is provided with an upper surface having a pattern of raised bumps, the configuration and spacing of which is such that a common pet bowl or dish can be placed on any part of the upper surface and the bowl will normally fall within the interstices between the pattern of bumps. The bumps prevent a bowl from moving around the mat, and a raised peripheral edge bordering the upper surface prevents spillage from escaping onto the mat support surface or floor. The mat is preferably formed from a tacky material, such a natural rubber, which further aids in the goal of reducing slippage of both the mat and the bowl placed thereon.

This application claims the benefit of provisional application 60/462,757, filed Apr. 14, 2003.

### FIELD OF THE INVENTION

The present invention relates to mats in general, and more particularly to a pet mat that is configured to prevent an object, such as a food or water bowl, from sliding around the top surface of the mat.

### BACKGROUND OF THE INVENTION

It is known art to place a dog mat under a feeding or water bowl. The mat serves a number of functions. It keeps the bowl from having direct contact with the floor, thereby preventing marking on the floor. Some mats also have sides to prevent spills from spreading from the bowl onto the floor of the pet owner's kitchen or other room.

However, existing mats have a major limitation. The bowl tends to slide around the top of the mat, which is generally a flat piece of plastic only interrupted by an occasional decorative rib with the logo or other decorative configuration on the top of said mat. Some mats also have dedicated bowl locations that prevent or inhibit varied bowl placement on the mat, thereby reducing the utility of the mat.

### SUMMARY OF THE INVENTION

The mat of the present invention overcomes the deficiencies of prior art mats through the use of a pattern of raised bumps. The configuration and spacing of said bumps is such that a common pet bowl or dish can be placed on any part of the top surface of the mat and the bowl will normally fall within the interstices between the pattern of bumps. In said manner, the bowl does not slide or slip around the mat. This helps prevent spillage on the mat itself so that in combination with the sides of the mat, the chance of spillage off of the mat onto the floor itself is greatly reduced. The mat is preferably formed from a tacky material, such a natural rubber, which further aids in the goal of reducing slippage. Such tacky material helps prevent both bowl slippage on the bowl-receiving surface of the mat as well as slippage of the mat itself on the floor.

### BRIEF DESCRIPTION OF THE DRAWINGS

FIG. 1 is a top view of an embodiment of the pet mat of the present invention.

FIG. 2A is a cross-sectional view taken through line 2A-2A in FIG. 1.

FIG. 2B is a close-up view of section 2B in FIG. 2A.

FIG. 3A is a cross-sectional view taken through line 3A-3A in FIG. 1.

FIG. 3B is a close-up view of section 3B in FIG. 3A.

FIGS. 4-7 illustrate potential bowl placement on the pet mat of FIG. 1.

### DETAILED DESCRIPTION OF THE PREFERRED EMBODIMENTS

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. In the various views of the drawings, like reference characters designate like or similar parts.

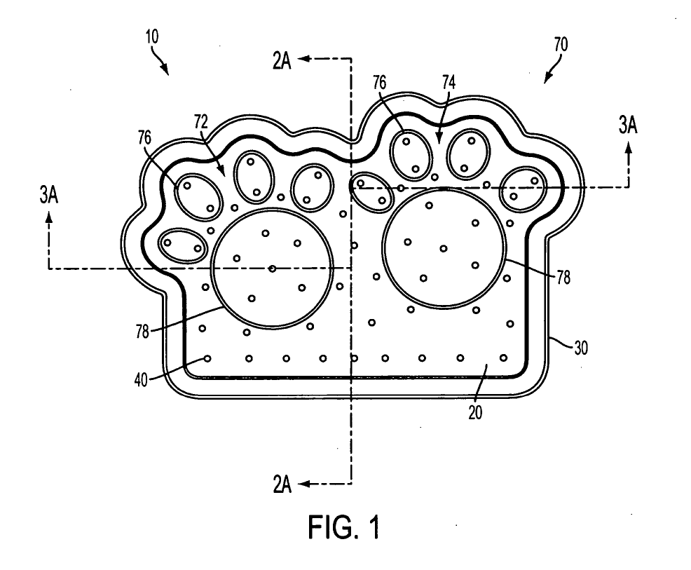

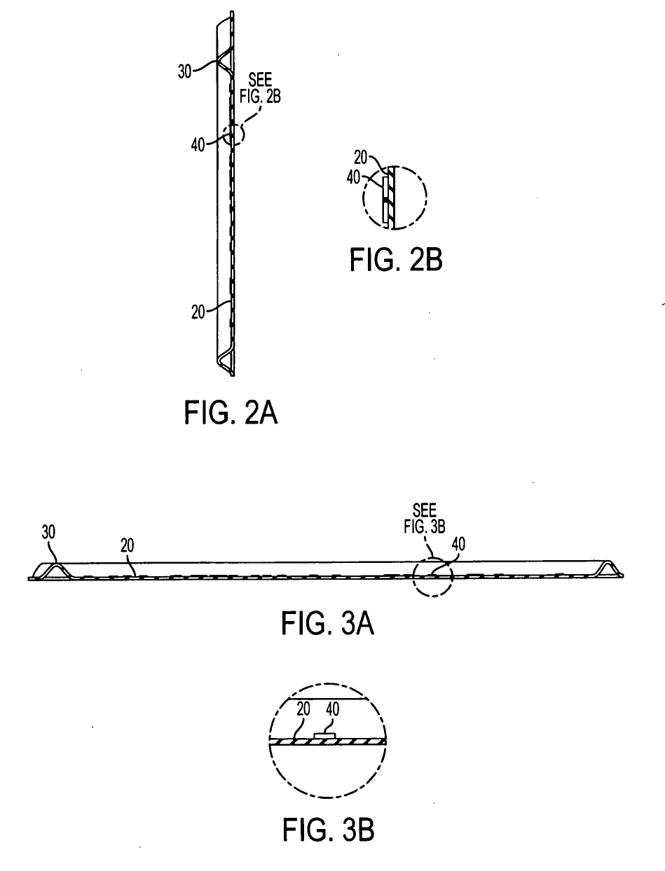

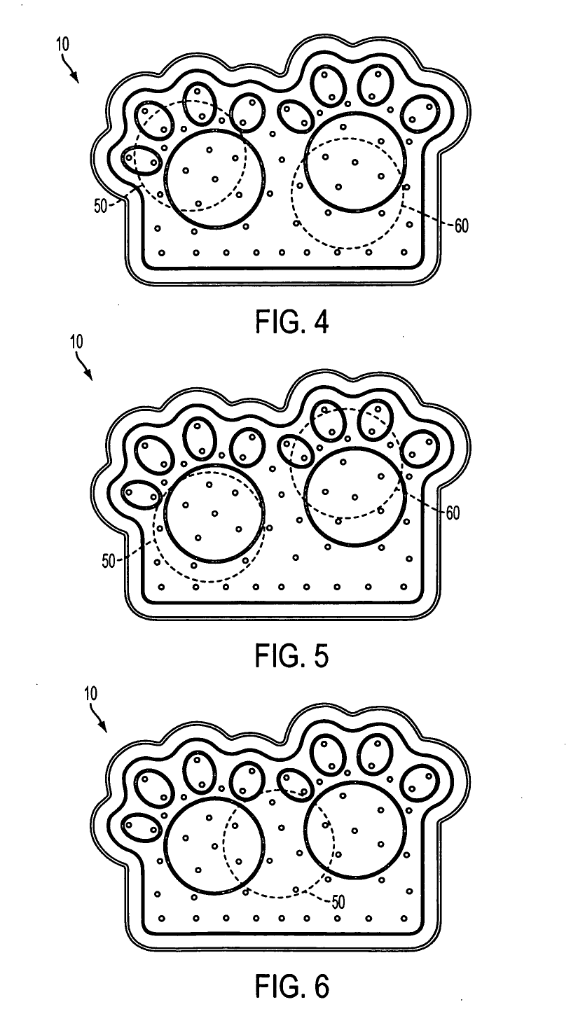

FIG. 1 illustrates a pet mat 10 of the present invention comprising an upper surface 20 bounded by a raised peripheral edge 30 and a plurality of raised bumps 40 arranged on said upper surface 20 in an irregular, asymmetric pattern. The bumps 40 are spaced such that a bowl 50 (see FIGS. 4-7) placed on said upper surface 20 is restrained by said bumps 40 in a plurality of non-dedicated locations. In other words, a bowl 50 or a plurality of bowls 50, 60 do not have to be placed in only one or two locations on the upper surface 20, but can be placed in many different locations as long as the bowl rims are situated within the interstices between the bumps 40. A series of bumps are spaced from the raised peripheral edge 30 to prevent a bowl placed on said upper surface 20 from moving toward or near said raised peripheral edge 30. Of course, while there is no danger if a pet bowl contacts the raised peripheral edge 30, the peripheral series of bumps serves to keep a pet bowl farther away from the edge of the mat 10, which may help contain food and/or water spillage within the confines of the upper surface 20 if the pet is a messy eater.

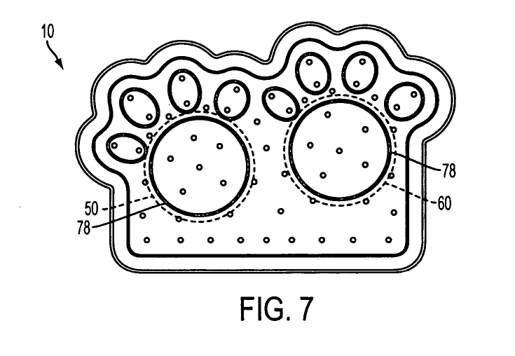

The raised peripheral edge 30 of the illustrated embodiment preferably has an irregular shape that is best seen from the top view of FIG. 1. For example, at least one portion 32 of the edge 30 is curved, while another portion 34 is straight or not curved. This illustrates a departure from the conventional pet mat having a raised peripheral edge, which is usually bowl-shaped or of another standard geometric configuration. In addition, the curved portion 32 approximately traces at least one aspect of a decorative image 70 embossed or imprinted on the upper surface 20 of the mat 10. In the illustrated embodiment, such image 70 is a pair of paw prints 72, 74 (although other ornamental designs are contemplated) comprising a plurality of oval digit locations 76, each digit outline 76 containing within a pair of bumps 40. The “palm” portion 78 of each paw print is preferably circular and may function as a location guide for a pet bowl (see FIG. 7). However, as shown in FIGS. 4-6, a pet bowl may be placed anywhere on the mat and not only within the “palm” portions 74.

The pet mat 10 of the present embodiment is preferably formed from a non-stick, tacky material, such as natural rubber. Other non-stick, tacky materials are contemplated. Such material prevents or inhibits a pet bowl from sliding or slipping around the mat 10 and helps prevent spillage on the upper surface 20 of the mat 10 so that, in combination with the raised peripheral edge 30, the chance of spillage off of the mat 10 onto a floor is greatly reduced. A tacky material also helps prevent slippage of the mat 10 itself on the floor.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A pet mat comprising:
a) an upper surface bounded by a raised peripheral edge, and
b) a plurality of raised bumps arranged on said upper surface in an irregular, asymmetric pattern.

2. A pet mat in accordance with claim 1, wherein said plurality of bumps are spaced such that a bowl placed on said upper surface is restrained by said bumps in a plurality of non-dedicated locations.

3. A pet mat in accordance with claim 1, wherein said raised peripheral edge has an irregular shape.

4. A pet mat in accordance with claim 3, wherein said raised peripheral edge has a shape that, when viewed from the top of the pet mat, is partially curved and partially straight.

5. A pet mat in accordance with claim 1, wherein said plurality of bumps further comprises a series of bumps spaced from the raised peripheral edge to prevent a bowl placed on said upper surface from moving toward said raised peripheral edge.

6. A pet mat in accordance with claim 1, wherein said pet mat is made from a non-stick, tacky material.

7. A pet mat in accordance with claim 6, wherein said tacky material is natural rubber.

8. A pet mat in accordance with claim 1, wherein said upper surface further comprises a decorative image and wherein said raised peripheral edge has a shape that is similar to a portion, but not the entirety, of said decorative image.

9. A pet mat in accordance with claim 8, wherein said decorative image further comprises a pair of paw prints.

10. A pet mat in accordance with claim 9, wherein each paw print is defined by a plurality of oval digits, each digit having a pair of raised bumps.

11. A pet mat in accordance with claim 9, wherein each paw print further comprises a circular palm portion adapted to form a location guide for a pet bowl.

12. A pet mat in accordance with claim 1, further comprising at least one bowl placement locator formed on said upper surface.

13. A pet mat in accordance with claim 12, wherein said at least one bowl placement locator is part of an ornamental design embossed or imprinted on said upper surface.

14. A pet mat formed from a non-stick, tacky material comprising:
a) an upper surface bounded by a raised peripheral edge, and
b) a plurality of raised bumps arranged on said upper surface in an irregular, asymmetric pattern,
c) wherein said plurality of bumps are spaced such that a bowl placed on said upper surface is restrained by said bumps in a plurality of non-dedicated locations, and
d) wherein said raised peripheral edge has an irregular shape.

15. A pet mat in accordance with claim 14, wherein said peripheral edge has a shape that, when viewed from the top of the pet mat, is partially curved and partially straight.

16. A pet mat in accordance with claim 14, wherein said plurality of bumps further comprises a series of bumps spaced from the raised peripheral edge to prevent a bowl placed on said upper surface from moving toward said raised peripheral edge.

17. A pet mat in accordance with claim 14, wherein said tacky material is natural rubber.

18. A pet mat in accordance with claim 14, wherein said upper surface further comprises a decorative image and wherein said raised peripheral edge has a shape that is similar to a portion, but not the entirety, of said decorative image.

19. A pet mat in accordance with claim 18, wherein said decorative image further comprises a pair of paw prints, each paw print being defined by a plurality of oval digits and a circular palm portion that is adapted to form a location guide for a pet bowl.
